(19) United States
(12) Patent Application Publication
(10) Pub. No.: US 2023/0141795 A1
(43) Pub. Date: May 11, 2023

(54) METHOD FOR GEOREFERENCING OF OPTICAL IMAGES

(71) Applicant: AIRBUS DS GEO SA, TOULOUSE (FR)

(72) Inventor: Philippe NONIN, TOULOUSE (FR)

(21) Appl. No.: 17/920,655

(22) PCT Filed: Apr. 16, 2021
(86) PCT No.: PCT/EP2021/059974

§ 371 Date: Oct. 21, 2022

(30) Foreign Application Priority Data
Apr. 23, 2020 (FR) FR2004045

(51) Int. Cl. G01C 11/06; G01S 13/86; G01S 13/90; G06T 7/33

(52) U.S. Cl. CPC G01C 11/06; G01S 13/867; G01S 13/9021; G06T 7/344; G06T 7/337; G06T 2207/10012; G06T 2207/10044; G06T 2207/20076

(57) ABSTRACT

A method (100) for referencing an optical image (19) including: obtaining (110, 120) a stereoscopic image pair (19, 23) of the optical image (19) and a SAR image (35), the surface areas covered by the images (19, 23, 35) on the ground having an overlapping area (39); selecting (130) an area of interest (42) in the overlapping area (39); from the area of interest (42): obtaining (140) a 3D model (40); calculating (150) a simulated radar image (44); estimating (160) an offset (di, dj) between the simulated image (44) and the radar image (35); selecting (170) a reference point (46); projecting (180) and shifting (di, dj) the reference point (46) in the radar image (35) to correct the radar connection point (46′″); determining (175) a pair of connection points (46′, 46″) in the image pair; and referencing the optical image (19) based on the connection points (46′, 46″, 46′″).

### TECHNICAL FIELD OF THE INVENTION

The present invention relates to an advanced method for georeferencing of optical images. More particularly, the invention relates to a method allowing referencing images acquired by high-resolution optical sensors on board machines for observing the surface of the Earth.

### PRIOR ART

The latest generations of optical sensors on board satellites offer very high spatial resolutions which can reach a resolution of fifty centimetres to thirty centimetres. During a shot taken by an optical sensor on board a satellite, the acquired image is obtained in the geometric frame of reference of the sensor, that is to say the geometric frame of reference in which the camera is located at the time of acquiring the image. This frame of reference therefore essentially depends on the position of the camera and its orientation. This is referred to as orbital position and attitude of the camera regarding a camera on board a satellite.

The accurate estimate of the orbital position of a camera on board a satellite can be obtained a posteriori quite easily. Unfortunately, estimating the attitude of this same camera is much more difficult to obtain and the obtained values induce ground location errors of the images captured by the camera which are much higher than the spatial resolution expected for this type of images. By way of example, the location errors of images from known optical Earth observation satellites can be greater than four metres.

In order to circumvent this problem of a priori knowledge of the attitude of the camera, a perfectly known technique of the state of the art is generally used in photogrammetry, called ‘bundle adjustment’ technique. The bundle adjustment techniques consist in simultaneously combining points defined in a three-dimensional or ‘3D’ reference frame defining the geometry of the scene, parameters representative of the relative displacement of the camera and the internal geometric features of the camera which are used for the acquisition of the image, in order to obtain an optimum representative of the projection of these 3D points in the image.

The bundle adjustment image referencing techniques therefore use points on the surface of the globe whose 3D coordinates are specifically known and whose position can be found in the image captured by the optical sensor. These points called support point or even usually ‘Ground Control Point’, are produced by techniques of ground surveys of the planimetric and altimetric coordinates of the identified remarkable point, often accompanied by an image thumbnail representing an aerial or satellite view of the considered point. The planimetric and altimetric accuracy of the used points and the geographical distribution thereof in the image depend on the referencing accuracy of the image obtained by this bundle adjustment method. To date, the available referencing databases of global geographic coverage have an absolute location accuracy of about three metres.

The new very high-resolution optical sensors on board the Earth observation satellites with the expected resolutions of fifty centimetres to thirty centimetres fall within the fields of application previously covered by aerial photography. The optimal exploitation thereof therefore requires a location accuracy compatible with these applications, that is to say in the range of one metre. The referencing of these images to achieve the desired location accuracies requires support points with a planimetric accuracy equal to one metre or even less. A manual punctual collection of support points with the desired accuracy is possible for a given set of optical images, but this is very costly and cannot be reasonably considered to obtain a global coverage necessary for the referencing of images acquired at any point of the terrestrial globe by a constellation of Earth surface observation satellites or by any other acquisition means on board a drone or an aircraft.

It is therefore necessary to find a method allowing accurately referencing very high resolution optical images acquired at any point on the terrestrial globe acquired by a constellation of Earth surface observation satellites or by any other acquisition means on board a drone or an aircraft in the most automated manner possible and this anywhere on the terrestrial globe where a referencing is possible. It is also necessary to find a method which does not require the use of a database of specific reference points.

### PRESENTATION OF THE INVENTION

The present invention aims at overcoming the drawbacks of the known optical image referencing methods with a totally innovative approach.

To this end, according to a first aspect, the present invention relates to a method for referencing at least one first optical image of the surface of the Earth taken by an optical sensor on board a satellite or on board an aircraft, the referencing method comprising the steps of: obtaining a stereoscopic optical image pair including the first optical image; obtaining at least one reference radar image taken by a synthetic aperture radar sensor, the surface area covered on the ground by the at least one reference radar image including an overlapping area with the surface area covered on the ground by the images of the stereoscopic optical image pair; and selecting at least one area of interest on the overlapping area.

For each of the areas of interest, the method comprises the steps: obtaining a 3D model on the area of interest from the stereoscopic optical image pair; calculating at least one simulated radar image on the at least one area of interest from the obtained 3D model and the acquisition parameters of the at least one reference radar image; estimating a geometric offset between the at least one simulated radar image and the at least one reference radar image; selecting at least one reference point on the 3D model of the area of interest; projecting the at least one reference point in the at least one reference radar image by a radar projection function so as to obtain at least one radar connection point; correcting the at least one radar connection point by applying the estimated geometric offset so as to obtain at least one corrected radar connection point; and determining at least one pair of connection points of the stereoscopic optical image pair by projection of said at least one reference point in each image of said stereoscopic optical image pair.

Finally, the method comprising a step of georeferencing of said at least one first optical image from at least the pair of optical connection points and from the at least one corrected radar connection point.

The invention is implemented according to the embodiments and variants set out below, which are to be considered individually or according to any technically operating combination.

Advantageously, the georeferencing step can comprise a single bundle adjustment step applied simultaneously to the stereoscopic optical image pair and to the at least one reference radar image.

The step of estimating the geometric offset can comprise maximising the conditional probability of the offset knowing the at least one reference radar image.

The step of calculating the at least one simulated radar image can comprise determining an average reflectance factor of the at least one reference radar image calculated on the area of interest considered for the calculation of the at least one simulated radar image.

Each area of interest of the overlapping area can be a restricted area of the overlapping area. The step of selecting at least one area of interest can include at least two areas of interest, preferably four areas of interest.

The step of obtaining a 3D model is carried out over the entire overlapping area, prior to the step of selecting at least one area of interest on the overlapping area.

The georeferencing step from at least the pair of optical connection points and the at least one corrected radar connection point can be produced on the two images of the stereoscopic optical image pair simultaneously.

According to a second aspect, the present invention relates to a system for georeferencing of at least one optical image for implementing the method for referencing at least one first optical image of the surface of the Earth described above, the system including an information processing unit and a random access memory associated with the information processing unit, said random access memory comprising instructions for implementing the method, said information processing unit being configured to execute the instructions implementing the method.

According to a third aspect, the present invention relates to a computer program product comprising instructions which, when the program is executed by a computer, lead it to implement the steps of the method for referencing at least one optical image described above.

According to a fourth aspect, the present invention relates to an information storage medium storing a computer program comprising instructions to implement, by a processor, the method described above, when said program is read and executed by said processor.

### BRIEF DESCRIPTION OF THE FIGURES

Other advantages, aims and features of the present invention emerge from the following description given, for explanatory and in no way limiting purposes, with reference to the appended drawings, in which:

FIG. 1 is a schematic representation of a non-limiting example of obtaining a stereoscopic optical image pair required for the method for referencing at least one optical image of the stereoscopic pair.

FIG. 2 is a schematic representation of a non-limiting example of obtaining a reference SAR image required for the method for referencing at least one optical image of the stereoscopic pair.

FIG. 3 is a schematic representation of obtaining a 3D model on an area of interest of an overlapping area between the stereoscopic optical image pair and the reference SAR image according to the invention.

FIG. 4 is a schematic representation of obtaining a simulated SAR image according to the invention.

FIG. 5 is a schematic representation of the determination of the geometric offset between the simulated SAR image and the reference SAR image according to the invention.

FIG. 6 is a schematic representation of the selection of reference points on the 3D model according to the invention.

FIG. 7 is a schematic representation of the determination of the connection points of the optical images from the 3D model according to the invention.

FIG. 8 is a schematic representation of the determination of the connection points of the radar images by projection from the 3D model according to the invention.

FIG. 9 is a schematic view of the bundle adjustment method of the method for referencing at least one optical image.

FIG. 10 is an example of a flowchart of the method for referencing at least one optical image according to the invention.

FIG. 11 is an example of a flowchart of the step of calculating the georeferencing of the process of FIG. 10.

FIG. 12 is a schematic representation of an example of a system for implementing the method for referencing at least one optical image according to FIG. 10.

### DESCRIPTION OF EMBODIMENTS

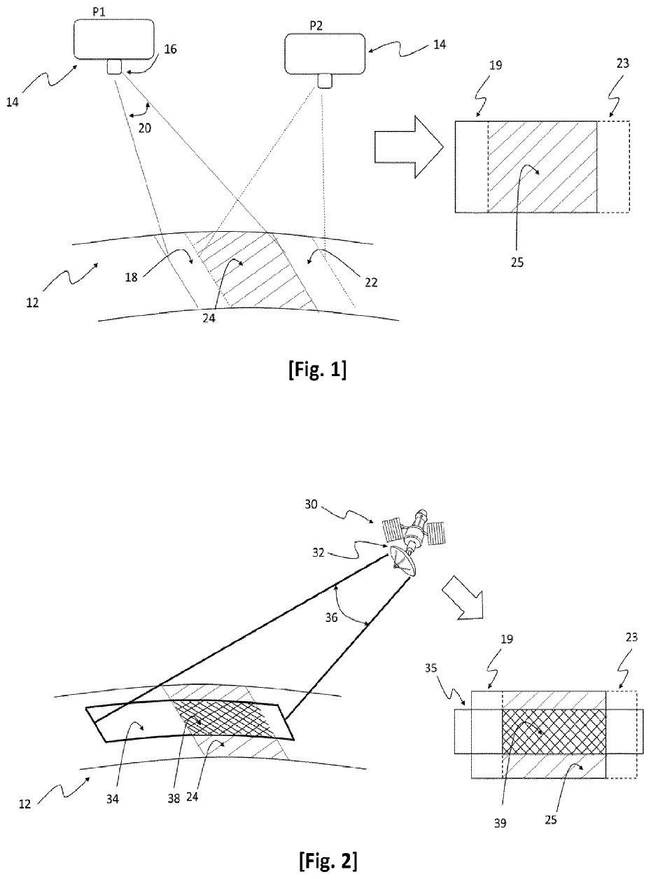

According to FIG. 1, a method for referencing at least one first optical image 19 whose surface area represents a first area 18 of the surface of the Earth 12, requires obtaining a second optical image 23 whose surface area represents a second area 22 of the surface of the Earth 12, the first area 18 and the second area 22 including a common area 24 of the surface of the Earth 12. In other words, the first optical image 19 and the second optical image 23 form a stereoscopic optical image pair 19, 23 including a surface area 25 common to the surface areas covered on the ground by the optical images representative of the common area 24 of the surface of the Earth 12.

By way of non-limiting example, and according to FIG. 1, the stereoscopic optical image pair 19, 23 can originate from a first acquisition and a second acquisition respectively of the first optical image 19 and the second optical image 23 by a high-resolution optical sensor 16 on board a flying machine 14 for observing the surface of the Earth 12 such as, for example and without limitation, a satellite for observing the surface of the Earth 12, or any other type of aircraft such as an Earth surface observation airplane, an Earth surface observation drone or a stratospheric Earth surface observation machine.

According to FIG. 1, for the purpose of acquiring the stereoscopic optical image pair 19, 23, the flying machine 14 for observing the surface of the Earth 12 is first located at a first position P1 so as to allow the acquisition of the first optical image 19 of the stereoscopic optical image pair 19, 23 according to a first angle of view and according to the field of view 20 of the optical sensor 16, then the flying machine 14 for observing the surface of the Earth 12 is located at a second position P2 which is distinct from the first position P1, so as to allow the acquisition of the second optical image 23 of the stereoscopic optical image pair 19, 23 according to a second angle of view which is distinct from the first angle of view.

Alternatively, the acquisition of the stereoscopic optical image pair 19, 23 may also have been carried out by two flying machines 14 for observing the surface of the Earth 12 each including an optical sensor comprising shooting characteristics which are identical or similar to the optical sensor of the other flying machine.

It should be noted that the process for referencing at least one first optical image 19 according to the invention is independent of any process of acquiring the stereoscopic optical image pair 19, 23. In this respect, obtaining the stereoscopic optical image pair 19, 23 required for referencing at least one of the optical images 19 of the stereoscopic optical image pair 19, 23 can also originate from one or more databases or archives of optical images originating from the same optical sensor, from sensors of the same type or of different types to the extent that the resolutions are comparable. A selection of the second optical image 23 forming the pair of stereoscopic images with the first optical image 19 from at least one database of optical images can be made. This selection takes into account the surface area covered on the ground by the first optical image 19 and the surface area covered on the ground by the second optical image 23 so as to form the stereoscopic optical image pair 19, 23 according to an appropriate stereoscopic angle defined by the base/height (B/H) ratio of the triangle formed by the 2 sensors and the observed scene. Preferably, this selection can take into account the possible shooting constraints of each of the optical images 19, 23 of the stereoscopic optical image pair 19, 23 such as, for example and without limitation, the date and time of the acquisitions, the presence of cloud, etc. . . . .

According to FIG. 2, the method for referencing at least the first optical image 19 requires obtaining at least one reference radar image 35 whose surface area represents a third area 34 of the surface of the Earth 12. The reference radar image 35 is obtained in such a way that the area 34 of the surface of the Earth 12 which it represents overlaps the common area 24 of the surface of the Earth 12 covered by the optical image pair 19, 23.

Each reference radar image 35 originates from a synthetic aperture radar sensor 32. According to the rest of the disclosure, all radar images acquired by a synthetic aperture radar sensor 32 will be called SAR images, the acronym ‘SAR’ meaning ‘Synthetic Aperture Radar’. To this end, the reference radar image will be called reference SAR image 35.

The acquisition of a SAR image 35 consists in measuring the radiation of the waves emitted by the SAR radar sensor 32 after their reflections on the surface of the Earth 12 while the acquisition of an optical image 19 consists in measuring the solar radiation reflected by each point located in the field of view 20 of the optical sensor 16.

By way of non-limiting example, and according to FIG. 2, each reference SAR image 35 can originate from an acquisition by a synthetic aperture radar sensor 32 on board a radar satellite 30 for observing the surface of the Earth 12. The radar satellite 30 allows the acquisition of a reference SAR image 35 representative of the area 34 of the surface of the Earth 12 covered by the field of observation 36 of the SAR radar sensor 32. Given their method of obtaining, each reference SAR image 35 has the particularity of including an overlapping area 39 between the surface area thereof and the surface area 25 common to the surface areas covered on the ground by the optical images 19, 23, the overlapping area 39 being able to be distinct from one reference SAR image 35 to another.

Alternatively, each reference SAR image 35 may originate from an acquisition by a synthetic aperture radar sensor 32 on board any other type of aircraft such as an Earth surface observation aircraft 12, an Earth surface observation drone 12 or a stratospheric Earth surface observation machine 12.

It should be noted that the method for referencing at least one first optical image 19 according to the invention is independent of any reference SAR image acquisition process 35. In this respect, obtaining the at least one reference SAR image 35 required for referencing at least one of the optical images 19 of the stereoscopic optical image pair 19, 23 can also originate from a database or archives of SAR image. The selection of the reference SAR image 35 from a database of SAR images can be carried out by taking into account the surface area thereof so as to form an overlapping area 39 with the surface area 25 common to the surface areas covered on the ground by the optical images 19 and 23.

It should be noted that the ground location of a reference SAR image 35 depends only on the estimate of the orbital position of the SAR radar sensor 32. The orbital position of the SAR radar sensor 32 is sufficiently accurate data whose induced error on the location of the SAR images is less than one metre for recent sensors.

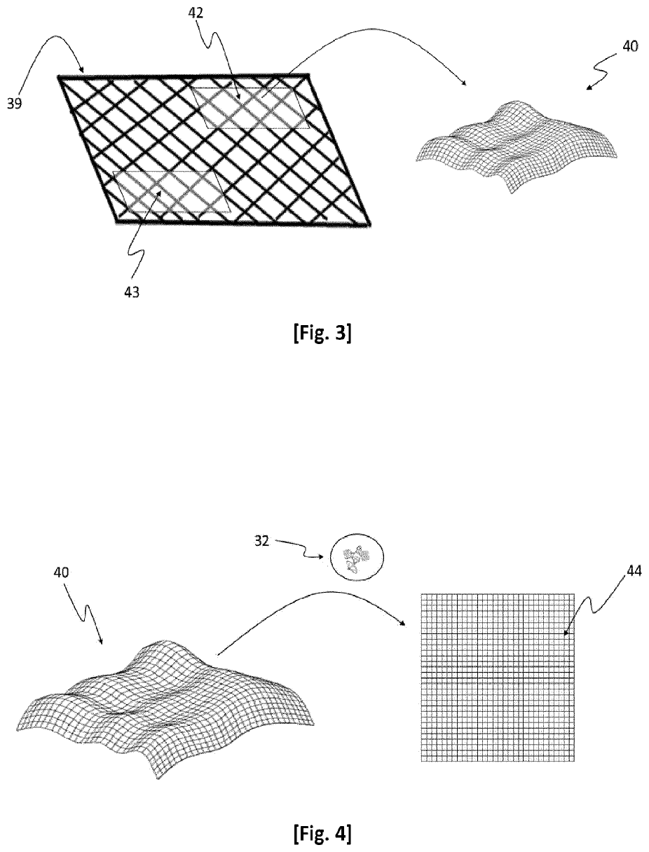

According to FIG. 3, the method for referencing at least the first optical image 19 requires the determination of at least one first three-dimensional model called first image 3D model 40 from the stereoscopic optical image pair 19, 23.

In general, the generation of a 3D model 40 is based on a well-known technique whose implementation comprises in particular a step of pairing the lines of sight of the two optical images 19, 23 of the stereoscopic pair, then the triangulation thereof. In other words, the generation of a 3D model 40 is obtained by a processing of the optical images 19, 23 of the stereoscopic pair according to a stereo matching processing. The obtained 3D model 40 may be of different natures depending on the outputs of the stereo matching method, such as for example and without limitation: a point-cloud in three dimensions resulting from the three-dimensional location of the points called homologous points identified in the stereo matching process; or even a grid representative of a regular sampling of the common portion 25 between the two optical images 19, 23 of the stereoscopic pair from the three-dimensional points obtained by the stereo matching process; or even a triangulated irregular network, called according to the acronym ‘TIN’, or even any mesh of any surface.

A possible geometric frame of reference of the first 3D model 40 obtained by the stereo matching process can be the object's frame of reference, that is to say the frame of reference related to the observed terrain. This frame of reference, called object's frame of reference, includes an uncertainty related to the geometric uncertainties of the stereoscopic optical image pair 19, 23 related in particular to the errors in estimating the attitude of the optical sensor 16.

Alternatively, the source of three-dimensional points of the 3D model 40 obtained by the stereo matching process can be an intermediate product of the stereoscopic correlation of the optical image pair 19, 23, that is to say a disparity map between the first optical image 19 and the second optical image 23 of the stereoscopic pair. According to this alternative, the disparity map describes the correspondence of the projections, in the first optical image 19 and in the second optical image 23, of each three-dimensional point of the first 3D model 40. Knowing the geometric shooting models, that is to say the characteristics of the optical sensor 16, as well as the orbital position and the attitude of the optical sensor 16, the passage from the disparity map to the object's frame of reference is immediate by triangulation.

According to FIG. 3, the first 3D model is generated from the overlapping area 39. To this end, the method for referencing at least the first optical image 19 of the stereoscopic pair comprises, preferably before the determination of the first 3D model 40, a selection of at least one first area of interest 42, commonly referred to by the acronym AOI. The selection of the at least one first area of interest 42 is performed on the overlapping area 39 between the stereoscopic optical image pair 19, 23 and the reference SAR image 35. The at least one first area of Interest 42 represents a portion of the overlapping area 39, preferably a restricted area of the overlapping area 39.

The number of areas of interest 42, 43 required for the method for georeferencing of optical images 19, 23 can depend on the complexity of the ground deformation generated by the orientation errors of the optical images 19, 23 expected to observe. Advantageously, a selection of a plurality of areas of interest 42, 43 on the overlapping area 39 allowing the generation of a plurality of 3D models 40 allows best estimating the referencing errors of at least the first optical image 19, in particular if the optical sensor 14 having allowed the acquisition of the first optical image 19 has been subjected to a greater number of degrees of freedom of movement generating complex deformations of the image. By way of non-limiting example, a selection of four distinct areas of interest 42, 43 can be a good compromise.

However, a selection of a single area of interest 42 may be sufficient in particular when the optical sensor 14 having allowed the acquisition of the first optical image 19 has only been subjected to a roll and a pitch generating a simple translation of the image that can be measured with a single area of interest.

The selection of the areas of interest 42 can be carried out both by an operator by selection in the overlapping area 39 between the optical images 19, 23 of the stereoscopic pair and the reference SAR image 35 and automatically. The selection of areas of interest 42, 43 can take into account the nature of the terrain, in particular, for example and without limitation, so as to avoid the water bodies, the backscattered electromagnetic energy of the synthetic aperture radars on the water bodies is not predictable. An advantage of the selection of at least one area of interest 42 is the simplification of the calculation, and therefore the duration of the calculation, required to generate the first 3D model 40.

This preferential mode of selecting at least one first area of interest 42 does not exclude an alternative embodiment according to which a single 3D model 40 can be generated over the entire overlapping area 39 prior to the step of selecting areas of interest.

According to the known state of the art, there is no direct correlation between an optical image 19 and an SAR image 35. Indeed, in the case of optical images 19, 23, the measured signal is scaled between the visible wavelengths and infrared wavelengths, that is to say wavelengths which can range from 0.4 micrometres to 3 micrometres, while the wavelength of a radar in X band as usually used for the observation of the surface of the Earth 12 is in the range of 31 millimetres. It is therefore not possible to simply pair the points of an optical image 19 with those of a SAR image 35 acquired by a SAR radar sensor 32 with the aim of finding a geometric relationship between the geometric model of shooting of said optical image 19 and that of said SAR image 35 for the purpose of referencing said optical image 19.

To this end and according to FIG. 4, the method for referencing at least the first optical image 19 requires, for each reference SAR image 35, the calculation of a simulated SAR image 44 on the at least one first area of interest 42, from in particular on the combination of the first 3D model 40 resulting from the stereoscopic optical image pair 19, 23 and the acquisition parameters of the reference SAR image 35.

The calculation of each simulated SAR image 44 takes into account the fact that the average electromagnetic energy backscattered on the surface of the terrain modelled by the first 3D model 40 depends on the angle of incidence of the SAR radar sensor 32 on the terrain modelled by the first 3D model 40 and the geometric configuration of the SAR radar sensor 32. In other words; the average backscattered electromagnetic energy also depends on the orientation of the terrain modelled by the first 3D model 40 relative to the incident wavefront that the SAR radar sensor 32 would have emitted. More particularly, knowing the first area of interest 42 represented by the first 3D model 40 and the geometric configuration of the SAR radar sensor 32 relative to the modelled terrain, the average electromagnetic energy backscattered by any terrain surface element modelled by the first 3D model 40, that is to say the radiation of the radar wave that the SAR radar sensor 32 would have emitted on the terrain surface modelled by the first 3D model 40 can be calculated to within a multiplicative constant. It should also be noted that a sufficiently fine triangulated representation of the relief modelled in the first 3D model 40, allows faithfully simulating the wave/surface interaction and its representation in the simulated SAR image 44.

For this purpose, the backscattered energy recorded in a SAR image 35 depends on a coefficient strongly related to the angle of the incident wave of the SAR radar sensor 32 on the terrain, the coefficient being determined according to the following formula,

$$\frac{C \times R}{sin ( i )} ,$$

formula according to which i represents the angle of the incident wave on the terrain modelled by the first 3D model 40, ‘C’ is a proportionality factor depending on the characteristics of the SAR radar sensor 32 such as, for example and without limitation, the distance between the SAR radar sensor 32 and the terrain, as well as the antenna gain, R represents the reflectance of the surface of the terrain at the considered point. According to the invention, it will be necessary to estimate a constant reflectance factor R over the entire terrain represented by the first 3D model 40. More particularly, the reflectance factor R used for calculating the simulated SAR image 44 is an average reflectance factor of the reference SAR image 35 calculated over the entire surface area covered on the ground by the simulated SAR image 44, that is to say over the area of interest 42 considered for calculating said simulated SAR image 44.

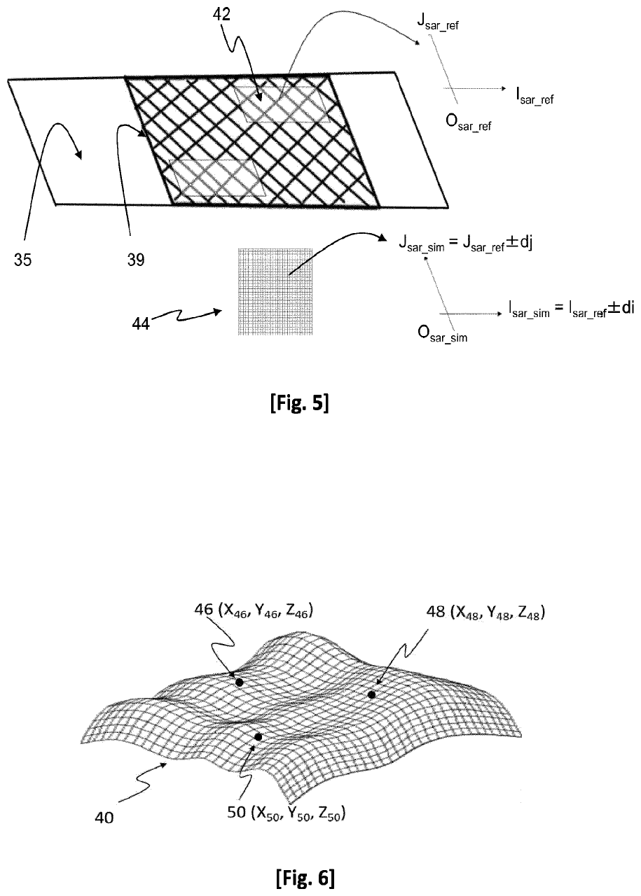

According to FIG. 5, the method for referencing at least the first optical image 19 requires an estimate of the geometric offset di, dj of each simulated SAR image 44 relative to the corresponding reference SAR image 35.

It should be noted that the simulated SAR image 44 is representative of the first area of interest 42 having been used to determine the first 3D model 44. Consequently, in a hypothesis for selecting a plurality of areas of interest 42, 43, the method for referencing at least the first optical image 19 requires an estimate of the offset di, dj of each simulated SAR image 44 each representative of an area of interest 42, 43 relative to the reference SAR image 35.

It is known from the prior art to be able to estimate the geometric offset between two images comprising an overlapping area according to a correlation product approach between the two images. The application of the correlation product approach is a generic approach which applies to both optical images and radar images.

According to the invention, preferably a new method or new method for estimating the offset di, dj between a simulated SAR image 44 and the corresponding reference SAR image 35, in the frame of reference O_{sar_ref}, I_{sar_ref}, J_{sar_ref} of the reference SAR image 35 has been developed. This approach is particularly suitable in the context of SAR images.

To this end, the new method for estimating the offset di, dj according to the invention comprises an estimate of the geometric offset di, dj by maximising the conditional probability of the offset di, dj knowing the reference SAR image 35. The conditional probability of the geometric offset di, dj knowing the reference SAR image 35 will be noted P(di, dj/SAR). According to Bayes' theorem, the conditional probability of the geometric offset di, dj knowing the reference SAR image 35 is calculated according to the formula:

P(di,dj/SAR)=P(SAR/di,dj)*P(di,dj)/P(SAR) (1)

In the context of the invention, the prior probability P(di, dj) is assumed to be constant over a finite interval [−i, +i][−j, +j], the prior probability P(di, dj) being zero beyond the bounds of the finite interval. The bounds of the finite interval [−i, +i][−j, +j] are determined by the maximum priori uncertainty of location of the optical images 19, 23 of the stereoscopic pair. This maximum prior uncertainty is translated into the maximum offset of the simulated SAR image 44 thanks to the location function of the reference SAR image 35, that is to say thanks to the projection of the terrain observed in the reference SAR image 35.

In the context of the invention, it is also noted that the prior probability P(SAR) does not depend on the geometric offset di, dj. This means that the operation consisting in maximising the conditional probability P(di, dj/SAR) of the geometric offset di, dj knowing the reference SAR image 35 is therefore equivalent to maximising P(SAR/di, dj) over the previously defined finite interval [−i, +i][−j, +j]. This last conditional probability P(SAR/di, dj) amounts to estimating the probability of the reference SAR image 35, knowing the statistical expectation of the backscattered energy in each pixel. It should be noted that the expectation of the backscattered energy was determined a priori for each pixel when determining the simulated SAR image 44 from the first 3D model 40.

Consequently, knowing that the residual fluctuations are statistically independent from one pixel of the reference SAR image 35 to another, the conditional probability P(SAR/di, dj) can be broken down according to the following formula representative of the product of the probabilities P_{α}_{ᵢ} of the statistical expectations of the backscattered energy a; for each pixel i of the simulated SAR image 44:

P(SAR/di,dj)=ΠᵢP_{α}_{ᵢ}(vᵢ) (2)

According to the formula, vᵢ represents the amplitude of the pixel i of the reference SAR image 35. It should be noted that the distribution P_{α}(v) is well described by a Nakagami law, and for a SAR image, called ‘multi-look’ or even N-look SAR image, this law is given by the formula:

$${P}_{a} ( v ) = 2 {v}^{2 N - 1} {e}^{- {Nv}^{2} / a} \frac{{N}^{N}}{( {a}^{N} ( N - 1 ) ! )} \qquad ( 3 )$$

In the particular case of a ‘single-look’ image, this expression is reduced to the well-known Rayleigh law whose formula is:

$${P}_{a} ( v ) = \frac{2 {ve}^{- {v}^{2} / a}}{a} \qquad ( 4 )$$

The estimate of the geometric offset or geometric correction di, dj for the first area of interest 42 then amounts to determining the maximum value among all values of the conditional probability P(SAR/di,dj) calculated on the previously predefined interval [−i, +i][−j, +j].

It should be noted that the reference SAR image 35 used by the present method can be either a single-look SAR image or a multi-look SAR image. The multi-look SAR image being a technique for processing a posteriori a radar image allowing reducing the presence of a multiplicative noise in the image, called speckle, due to the nature of the radar signal measured by the sensor at the time of the acquisition.

According to FIG. 6, the method for referencing at least the first optical image 19 requires a selection of three-dimensional points 46, 48, 50 called reference points 46, 48, 50 associated with the first 3D model 40. Each reference point 46, 48, 50 includes 3D coordinates X₄₆, Y₄₆, Z₄₆, X₄₈, Y₄₈, Z₄₈, X₅₀, Y₅₀, Z₅₀ relating to the frame of reference of the first 3D model 40. In this regard, the method for referencing at least the first optical image 19 comprises a selection of the reference points 46, 48, 50 on each 3D model 40 obtained from at least the first area of interest 42. The selection criteria are essentially related to the confidence granted in the validity of the pairing of the pair of stereoscopic optical images 19, 23. The level of confidence is generally quantified by a pairing algorithm calculating a correlation score between each point of the first and second optical images 19, 23, and possibly by heuristics linked to the morphology of the terrain such as for example and without limitation, the low slope of the modelled terrain. Consequently, an automatic selection of the reference points 46, 48, 50 is possible according to the invention.

More particularly, the selection criteria are essentially based on the reliability of the matching of the optical image pair 19, 23. This reliability is given by the correlation score or also referred to as the confidence index for each point 46, 48, 50 obtained by the stereo pairing process also called stereo matching process. In general, the higher the score, the more reliable the pairing of the two points, each associated with an optical image 19, 23 of the stereoscopic pair of images 19, 23. According to the invention, the criterion relating to the reliability of the pairing is preferably also associated with a selection heuristic based on the local slope of the terrain modelled at the considered point. In practice, the locally flat surfaces are easier to pair. Generally, the selection of points on flat areas is preferred. Other heuristics are possible, such as for example and without limitation, the texture of the optical images, more particularly, a well-marked texture on the optical images 19, 23, that is to say areas with high radiometric contrast are preferred.

The selected number of reference points 46, 48, 50 should also be considered carefully. At least, one point of the first 3D model 40 originating from the first area of interest 42, is essential to the method for referencing at least the first optical image 19. Preferably, in order to prevent an inaccurate pairing of the stereoscopic image pair 19, 23 at a single selected point, a selection of a plurality of points allowing a certain redundancy is preferred.

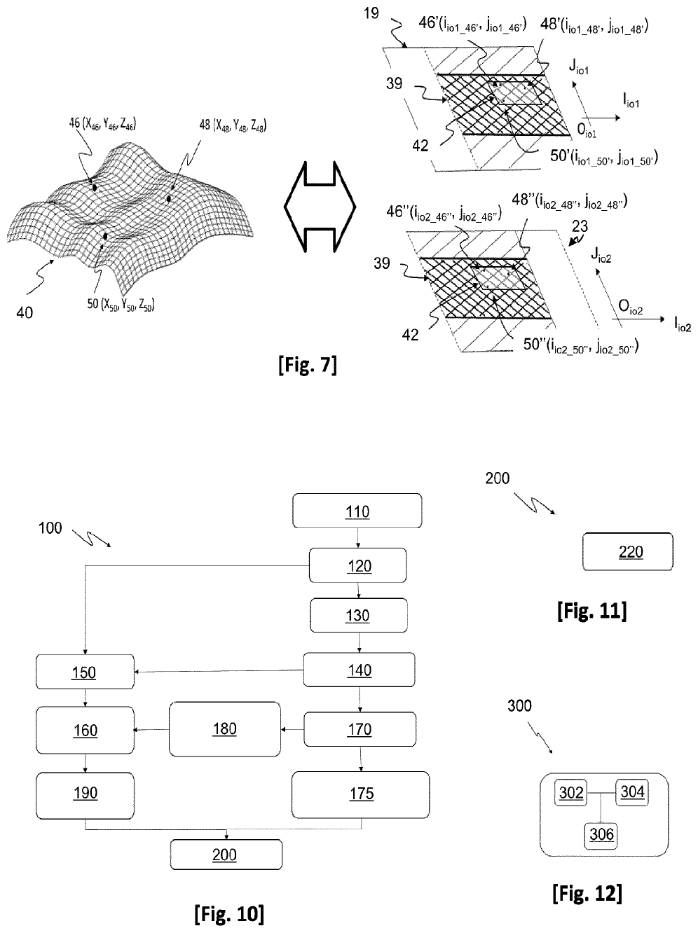

According to FIG. 7, the reference points 46, 48, 50 selected on the first 3D model 40 correspond to points called connection points 46′, 48′, 50′ of the first optical image 19 and to connection points 46″, 48″, 50″ of the second optical image 23. More particularly, it should be noted that the first 3D model 40 is a three-dimensional representation of the first area of interest 42 selected on the overlapping area 39 of the surface areas covered on the ground by the stereoscopic optical images 19, 23 with the surface area covered on the ground by the reference SAR image 35. In addition and as shown in FIG. 3, the first 3D model 40 is obtained by a processing of the optical images 19, 23 of the stereoscopic pair according to a stereo matching processing of the first optical image 19 and the second optical image 23.

To this end, and according to FIG. 7, each reference point 46, 48, 50 selected on the first 3D model 40 corresponds to a stereoscopic pair of pixels 46′, 46″, 48′, 48″, 50′, 50″ of the stereoscopic optical image pair 19, 23. Each pixel of the first optical image 19 and each pixel of the second optical image 23 corresponding to the selected reference points 46, 48, 50 therefore includes respectively image coordinates called optical image coordinates I_{io1_46′}, J_{io1_46′}, I_{io1_48′}, J_{io1_48′}, I_{io1_50′}, J_{io1_50′} in the first optical image 19, and optical image coordinates I_{io2_46″}, J_{io2_46″}, I_{io2_48″}, J_{io2_48″}, I_{io2_50″}, J_{io2_50″} in the second optical image 23 obtained by projection of the reference points selected in the first 3D model in the image's frame of reference of each image of the stereoscopic optical image pair 19, 23.

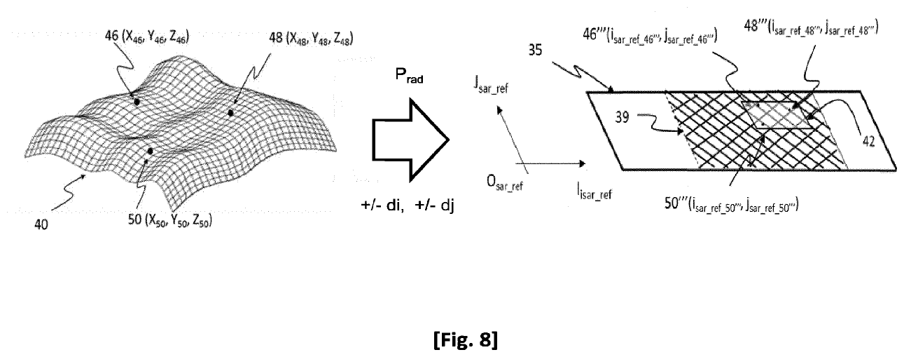

According to FIG. 8, the method for referencing at least the first optical image 19 requires the determination of connection points of the at least one reference SAR image 35 from the reference points 46, 48, 50 selected on the first 3D model 40. It should be noted that the first 3D model 40 is a three-dimensional representation of the first area of interest 42 selected on the overlapping area 39 of the surface areas covered on the ground by the stereoscopic optical images 19, 23 with the surface area covered on the ground by the at least one reference SAR image 35.

To this end, a radar projection function P_{rad} taking into account the radar acquisition parameters such as, for example and without limitation, the trajectory of the SAR radar sensor 32, allows determining radar connection points. According to the invention, the application of the geometric offset di, dj on the coordinates of the radar connection points allows obtaining the coordinates i_{sar_ref_46′″}, j_{sar_ref_46′″}, i_{sar_ref_48′″}, j_{sar_ref_48′″}, i_{sar_ref_50′″}, j_{sar_ref_50′″} of connection points, called corrected radar connection points 46′″, 48′″, 50′″ required for the method for referencing at least the first optical image 19 according to the invention.

According to FIG. 7 and according to FIG. 8, the method for referencing at least the first optical image 19 allowed projecting the reference points 46, 48, 50 selected on the first 3D model 40, in the image's frame of reference of the first optical image 19, of the second optical image 23 and of the at least one reference SAR image 35.

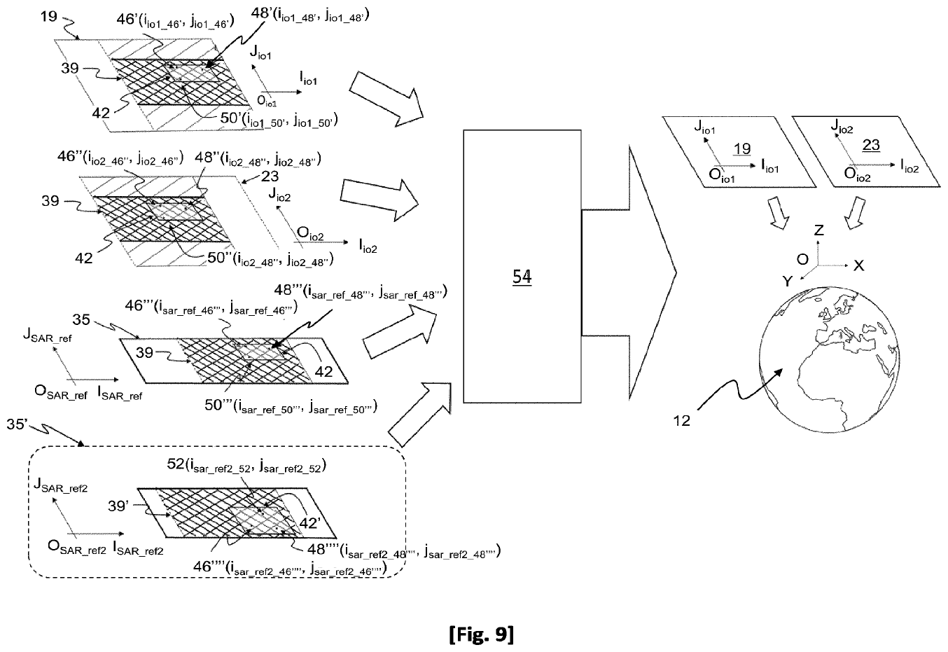

According to FIG. 9, the method for referencing at least the first optical image 19 allows the accurate location of the optical images 19, 23 of the stereoscopic pair in the object's frame of reference O, X, Y, Z, from the set of previously determined connection points, that is to say from the connection points 46′, 48′, 50′ of the first optical image 19, from the connection points 46″, 48″, 50″ of the second optical image 23 and from the corrected radar connection points 46′″, 48′″, 50″ of the at least one reference SAR image 35.

According to a first embodiment, the method for referencing at least the first optical image 19 requires a single bundle adjustment method, applied simultaneously to the optical images 19, 23 of the stereoscopic pair and to the at least one reference SAR image 35. To this end, according to this first embodiment, the single bundle adjustment method 54 will be called ‘simultaneous bundle adjustment method’.

According to this simultaneous bundle adjustment method, the only considered measurements are the connection points 46′, 48′, 50′ of the first optical image 19, the connection points 46″, 48″, 50″ of the second optical image 23 and the corrected radar connection points 46′″, 48′″, 50″ of the at least one reference SAR image 35. In accordance with the bundle adjustment principle, each measurement is associated with a prior uncertainty, which allows simultaneously estimating all variables in a probabilistic framework, such as, for example and in a without limitation, the coordinates of the image points, the coordinates of the terrain points and the shooting parameters of each used image. It should be noted that the uncertainty on the position parameters associated with the at least one references SAR image 35 is very low, the at least one reference SAR image 35 being natively accurate. The uncertainty on the position parameters associated with the SAR images being lower than that on the parameters of the optical images, it induces a strong constraint on the solution of the simultaneous bundle adjustment method.

To this end, the method for simultaneous bundle adjustment of the optical images 19, 23 of the stereoscopic pair and at least one reference SAR image 35 is based on the previously estimated measurements, namely:

\hat{X}_{3D_i}, Ŷ_{3D_i}, \hat{Z}_{3D_i}: estimated terrain coordinates of the selected reference points.

\hat{x}iⱼ, ŷiⱼ: coordinates of the connection points 46′, 46″, 46′″, 48′, 48″, 48′″, 50′, 50″, 50′″ in each optical image 19, 23 of the stereoscopic pair and in the at least one reference SAR image 35.

\hat{P}ᵢⱼ: estimated shooting parameters of each optical image 19, 23 of the stereoscopic pair and of the at least one reference SAR image 35.

σ_{X}, σ_{Y}, σ_{Z}: uncertainties on the terrain coordinate measurements.

σₓ, σ_{y}: uncertainties on the image coordinate measurements (which may be different for the optical and SAR images).

σₚ: uncertainties on the measurement of the shooting parameters of the images 19, 23 of the stereoscopic pair and of at least one reference SAR image 35, this uncertainty being different for the optical images and the SAR images.

The simultaneous bundle adjustment method allows the following variables to be estimated simultaneously:

Xᵢ, Yᵢ, Zᵢ: re-referenced terrain coordinates of the selected reference points.

Pᵢⱼ: corrected shooting parameters of the optical images 19, 23 of the stereoscopic couple and of the at least one reference SAR image 35.

xy(Pᵢⱼ, Xᵢ, Yᵢ, Zᵢ): projection of the reference points in the optical images 19, 23 of the stereoscopic pair and of the at least one reference SAR image 35.

The simultaneous bundle adjustment method consists in estimating the variables, that is to say, the terrain coordinates of the reference points and the shooting parameters, minimising the following mathematical expression:

$${\sum }_{i} {( \frac{{X}_{i} - {\hat{X}}_{i}}{{σ}_{X}} )}^{2} + {( \frac{{Y}_{i} - {\hat{Y}}_{i}}{{σ}_{Y}} )}^{2} + {( \frac{{Z}_{i} - {\hat{Z}}_{i}}{{σ}_{Z}} )}^{2} + {\sum }_{i , j} {( \frac{{P}_{ij} - {\hat{P}}_{ij}}{{σ}_{p}} )}^{2} + {\sum }_{i , j} {( \frac{x ( {P}_{0 j} , {P}_{nj} , {X}_{i} , {Y}_{i} , {Z}_{i} ) - {\hat{x}}_{ij}}{{σ}_{x}} )}^{2} + {\sum }_{i , j} {( \frac{y ( {P}_{0 j} , {P}_{nj} , {X}_{i} , {Y}_{i} , {Z}_{i} ) - {\hat{y}}_{ij}}{{σ}_{y}} )}^{2}$$

for which, ‘I’ represents the number of selected reference points and the index of each reference point and represents the number of optical images 19, 23 and reference SAR images 35 which are considered.

An advantage of the simultaneous bundle adjustment method applied to the method for referencing at least the first optical image 19 is to simultaneously model all parameters and the prior uncertainties thereof. The obtained overall solution, based on a more powerful conceptual framework, is more robust and accurate. In addition, this framework allows an a posteriori evaluation of the quality of the obtained estimate.

Finally, another advantage of the simultaneous bundle adjustment method applied to the method for referencing at least the first optical image 19 lies in its flexibility of use: it is indeed possible to use any number of optical images 19, 23 and reference SAR images 35, 35′, and there is no requirement that each reference point be seen in more than one reference SAR image 35, 35′. In the case where a single reference SAR image 35 is used, the referencing of the first optical image 19 is dependent on the resolution of the obtained 3D model 40. With a 3D model very well resolved at altitude, the 3D coordinates of the reference points are sufficiently defined for the referencing of the optical images to be satisfactory. Otherwise, the 3D coordinates X₄₆, Y₄₆, Z₄₆, X₄₈, Y₄₈, Z₄₈, X₅₀, Y₅₀, Z₅₀ of the reference points 46, 48, 50 may be imperfectly defined and there may remain a degree of freedom in the location of the optical images 19, 23. It frequently happens that the altitude of remarkable points visible in the optical images 19, 23 is known accurately (coast for example). The introduction of these points, of which only the image coordinates and the altitude are known, in the bundle adjustment allows removing this residual degree of freedom and, thus, compensating for the absence of another reference SAR image 35′. In the case where two or more reference SAR images 35, 35′ are used, with very distinct geometric acquisition configurations, in particular different angles of incidence, even if each point is not seen simultaneously on several images, the geometric constraints induced in the simultaneous bundle adjustment method remove the residual degree of freedom observed in the case of a single reference SAR image 35.

According to this embodiment of the referencing method using two or even several reference SAR images 35, 35′, the selection as reference SAR image of images acquired by any synthetic aperture radar satellite over the considered area according to opposite directions of sight constitutes a geometric configuration which is sufficient to obtain a stereoscopic angle (B/H) suitable for the present method. Thus, mention may be made, according to a first example, to the use of at least one SAR image acquired by a synthetic aperture radar satellite over the considered area according to a direction of sight oriented towards the East and of at least one SAR image acquired by a synthetic aperture radar satellite over the considered area in a direction of sight oriented towards the West, as a geometric configuration which is sufficient to obtain a stereoscopic angle B/H suitable for the present method. According to another example relating to the TerraSAR-X synthetic aperture radar satellite, the use as reference SAR images of a SAR image acquired by the satellite in ascending mode over the considered area and of another SAR image acquired by the satellite in descending mode over the considered area, according to the direction of passage of the satellite, is also a geometric configuration which is sufficient to obtain a stereoscopic angle (B/H) suitable for the present method.

The use by the method of a plurality of reference SAR images 35, 35′ with distinct geometrical configurations, therefore allows multiplying the number of reference points 46, 48, 50 resulting from 3D models 40 which are not necessarily obtained on the same, and not necessarily identical, areas of interest from one reference SAR image 35 to another and thus improving the accuracy of referencing the optical images 19, 23. Finally, the use by the method of a plurality of stereoscopic optical image pairs 19, 23 on the same area of the surface of the Earth allows multiplying, for the same ground point, the number of connection points in all used reference SAR images 35, 35′ and in all optical images 19, 23 of the stereoscopic pairs in order to further refine the referencing accuracy. The use by the method of a plurality of stereoscopic pairs of optical images 19, 23 available on the same area of the surface of the Earth also offers the advantage of being able to simultaneously reference all optical images 19, 23 of the stereoscopic pairs selected through a single and same step of simultaneous bundle alignment implemented by the method, thus improving the accuracy and consistency of the referencing of the optical images 19, 23 therebetween.

Alternatively to the method for referencing at least the first optical image 19 using a single simultaneous bundle adjustment method, in the case of two or even several reference SAR images 35, 35′, it is possible to carry out the referencing method according to a first step of stereoscopic triangulation of the connection points of the reference SAR images 35, 35′ so as to obtain terrain coordinates representative of these connection points in the object's frame of reference, then to execute a conventional bundle adjustment method on the optical images by using these terrain coordinates which are calculated as many support points (Ground Control Point or GCP) used as parameters in the conventional bundle adjustment method.

Based on the referencing method as described according to the invention, it is possible to consider any type of application on an optical image 19 with an absolute gain in accuracy, such as for example and without limitation:
Producing a 3D model by stereo pairing to the accuracy of the re-referenced high resolution optical images 19, 23.
Carrying out an ortho-rectification of the optical images 19, 23 in a given geographical or map frame of reference.
Carrying out any type of image processing of the terrain classification or even remote-sensing type.

According to FIG. 10, the method 100 for referencing at least the first optical image 19 described in the preceding figures can, for example and without limitation, comprise a plurality of steps.

The method 100 must comprise a step 110 of obtaining a pair of stereoscopic images comprising the first optical image 19 and a second optical image 23 such that the surface area covered on the ground by the first optical image 19 and the surface area covered on the ground by the second optical image 23 comprise a common surface area 25. Said common surface area 25 corresponds to the common area 24 of the Earth's surface of the area 18 of the Earth's surface covered by the first optical image 19 with the area 22 of the Earth's surface covered by the second optical image 23.

The method 100 must comprise a step 120 of obtaining at least one reference SAR image 35, from a synthetic aperture radar sensor 32, called SAR radar sensor 32. The surface area 34 of the at least one reference SAR image 35 includes an overlapping area 39 with the surface area covered on the ground by each optical image 19, 23 of the stereoscopic pair, the overlapping area 39 corresponding to the overlapping area 38 between the area 34 of the Earth's surface covered on the ground by the reference SAR image and the areas 18 and 22 of the Earth's surface the optical image pair 19, 23.

A step following the two preceding steps can comprise the selection 130 of at least one first area of interest 42 from the overlapping area 38 corresponding to the overlapping area 39. Said at least one first area of interest 42 is a restricted area of overlapping area 39. As shown in FIG. 3, the selection of the at least one first area of interest 42 can be performed both manually by an operator and automatically.

One of the following steps consists of a step 140 for obtaining a first 3D model 40 from the selection of at least one first area of interest 42 according to the preceding step. Obtaining the first 3D model 40 allows the method 100 to comprise a step 150 of calculating at least one simulated SAR image 44, in particular by combining the information from the first 3D model 40 and the parameters of the SAR radar sensor 32 having allowed the acquisition of the at least one corresponding reference SAR image 35.

It should be noted that the step 140 of obtaining a 3D model can be performed from the entire overlapping area 39 prior to the step 130 of selecting at least one first area of interest 42.

The calculation step 150 and the obtaining of the at least one simulated SAR image 44 on the at least one first area of interest 42, allows the method 100 to comprise an estimation step 160 of the geometric correction di, dj, between the at least one simulated SAR image 44 and the corresponding reference SAR image 35.

Obtaining the first 3D model 40 also allows the method 100 to include a step 170 of selecting at least one 3D point called the reference point 46 on the first 3D model 40.

The method 100 for georeferencing of at least the first optical image 19 comprises a step of radar projection 180 of said at least one reference point 46 in the at least one reference SAR image 35 so as to obtain at least one radar connection point. The method 100 comprises an additional step 190 of correcting the at least one radar connection point by applying the offset di, dj on said at least one radar connection point so as to obtain at least one corrected radar connection point 46′″ in the at least one reference SAR image 35.

The method 100 for georeferencing of at least the first optical image 19 also comprises a step 175 of determining at least one pair of connection points 46′, 46″ of the stereoscopic optical image pair 19, 23 by projection of said at least one reference point 46 in the frame of reference of the first optical image 19 and in the frame of reference of the second optical image 23.

Finally, the method 100 for georeferencing of at least the first optical image 19 comprises a last step 200 of georeferencing of at least the first optical image 19 from the at least one corrected radar connection point 46′ of the at least one reference SAR image 35 and at least one pair of corresponding connection points 46′, 46″ of the stereoscopic optical image pair 19, 23.

According to an alternative embodiment of the georeferencing method 100, this last step 200 of georeferencing is carried out simultaneously from at least the pair of optical connection points 46′, 46″ and the at least one corrected radar connection point 46′″ on the two images of the stereoscopic optical image pair 19, 23.

More particularly, according to FIG. 11 and according to a first alternative, the georeferencing step 200 of the referencing method 100 comprises a single step called simultaneous bundle adjustment step 220 applied simultaneously to the optical images 19, 23 and to the at least one reference SAR image 35.

According to FIG. 12, a system 300 for implementing the method 100 for referencing at least the first optical image 19 can comprise an information processing unit 302 of the processor type such as, for example and without limitation, a processor specialised in signal processing, or even a microcontroller, or any other type of circuit allowing executing software type instructions. The system 300 also includes random access memory 304 associated with the information processing unit 302. The information processing unit 302 is configured to execute a program, also called computer program, comprising instructions implementing the method 100 for referencing at least the first optical image 19 described above. The instructions are loaded into the random access memory of the system 300 from any type of storage media 306 such as, for example and without limitation, a memory of the non-volatile type or an external memory such as a removable storage memory card. The instructions can also be loaded via a connection to a communication network.

Alternatively, the computer program, comprising instructions implementing the method 100 for referencing at least the first optical image 19 can also be implemented in hardware form by a machine or by an integrated circuit specific to an application or else by an electronic circuit of the programmable logic network type.

It should be understood that the detailed description of the subject of the invention, given solely by way of illustration, does not, in any manner, constitute a limitation, the technical equivalents also being comprised within the scope of the present invention.

1. A method for referencing at least one first optical image of the surface of the Earth taken by an optical sensor on board a satellite or on board an aircraft comprising the steps of:
obtaining a stereoscopic optical image pair including the at least one first optical image;
obtaining at least one reference radar image taken by a synthetic aperture radar sensor, a surface area covered on the ground by the at least one reference radar image including an overlapping area with a surface area covered on the ground by the at least one first optical image of the stereoscopic optical image pair;
selecting at least one area of interest on the overlapping area;
the method further comprising for each of the at least one area of interest:
obtaining a three-dimensional (3D) model of the at least one area of interest from the stereoscopic optical image pair;
calculating at least one simulated radar image on the at least one area of interest from the obtained 3D model and acquisition parameters of the at least one reference radar image;
estimating a geometric offset between the at least one simulated radar image and the at least one reference radar image;
selecting at least one reference point on the 3D model of the area of interest;
projecting the at least one reference point in the at least one reference radar image by a radar projection function to obtain at least one radar connection point;
correcting the at least one radar connection point by applying the estimated geometric offset to obtain at least one corrected radar connection point;
determining at least one pair of connection points of the stereoscopic optical image pair by projection of said at least one reference point in each image of said stereoscopic optical image pair; and
georeferencing said at least one first optical image from at least the pair of optical connection points and from the at least one corrected radar connection point.

2. The method according to claim 1, wherein the georeferencing step comprises a single bundle adjustment step applied simultaneously to the stereoscopic optical image pair and to the at least one reference radar image.

3. The method according to claim 1, wherein the step of estimating the geometric offset comprises maximising a conditional probability of the geometric offset using the at least one reference radar image.

4. The method according to claim 1, wherein the step of calculating the at least one simulated radar image comprises determining an average reflectance factor of the at least one reference radar image calculated on the area of interest considered for the calculation of the at least one simulated radar image.

5. The method according to claim 1, wherein the at least one area of interest of the overlapping area is a restricted area of the overlapping area.

6. The method according to claim 1, wherein the step of selecting at least one area of interest includes at least two areas of interest.

7. The method according to claim 1, wherein the step of obtaining a 3D model is carried out over the entire overlapping area prior to the step of selecting at least one area of interest on the overlapping area.

8. The method according to claim 1, wherein the georeferencing step from at least the pair of optical connection points and the at least one corrected radar connection point is produced on the two images of the stereoscopic optical image pair simultaneously.

9. A system for georeferencing of at least one optical image including:
an information processing unit, and
a random access memory associated with the information processing unit, said random access memory comprising instructions for implementing the method of claim 1,
wherein said information processing unit is configured to execute the instructions for implementing the method of claim 1.

10. A computer program product comprising instructions which, when the program is executed by a computer, which causes the computer to implement the steps of the method of claim 1.

11. An information storage medium storing a computer program comprising instructions to implement, by a processor, the method according to claim 1, when said program is read and executed by said processor.
